(19) United States
(12) Patent Application Publication
(10) Pub. No.: US 2026/0250998 A1
(43) Pub. Date: Aug. 27, 2026

(54) BUFFER COMPONENT FOR SLIDING DOORS

(71) Applicants: Longlong Ye, Guangzhou (CN); Shuchan Huo, Zhongshan (CN)

(72) Inventors: Longlong Ye, Guangzhou (CN); Shuchan Huo, Zhongshan (CN)

(21) Appl. No.: 19/085,101

(22) Filed: Mar. 20, 2025

(30) Foreign Application Priority Data
Feb. 25, 2025 (CN) 202520312796.8

(51) Int. Cl. E05F 5/00

(52) U.S. Cl. CPC E05F 5/003; E05Y 2600/12; E05Y 2600/502

(57) ABSTRACT

A buffer component for sliding doors is provided, which includes a slide rail that is provided with a recess, a buffer is provided in the recess. An outer wall of the slide rail is slidably connected to a wheel, a width of the buffer is less than or equal to a width of the recess. The wheel includes a fixed shell, one side of the fixed shell is provided with an anti-jump component for clamping with the buffer. The anti-jump component includes an anti-jump column, and a length of a bottom long side of the anti-jump column is less than or equal to the width of the recess. The buffer component for sliding doors has been optimized, which significantly improves the convenience of installation and maintenance. The width of the buffer is less than or equal to the width of the recess, rendering it easy to install and replace.

### CROSS-REFERENCE TO RELATED APPLICATIONS

This application claims priority to Chinese Patent Application No. 202520312796.8, filed on Feb. 25, 2025, which is hereby incorporated by reference in its entirety.

### TECHNICAL FIELD

The present disclosure relates to the field of sliding door components technologies, and in particular, to a buffer component for sliding doors.

### BACKGROUND

Sliding door buffer component is a widely used device in modern home and commercial spaces, which mainly includes slide rails, wheels, and buffers. These components work together to ensure smooth operation and reduce noise during the opening and closing process of the sliding door. The slide rail is usually fixed to a door frame, and the wheels are provided on the sliding door and move along the slide rail. The buffer is provided inside the slide rail, and its main function is to provide a buffering effect for the wheels when the door is closed, thereby achieving a smooth closing action.

However, in practical use, traditional sliding door buffer components have some significant problems. Firstly, its installation process is complex and time-consuming, requiring high precision, which not only increases the difficulty of installation and disassembly, but may also lead to installation errors or unstable situations.

The present disclosure provides a buffer component for sliding doors to solve the problems of inconvenient installation and maintenance of traditional sliding door buffer components.

### SUMMARY

The purpose of the present disclosure is to solve the problem of inconvenient installation and maintenance of traditional sliding door buffer components. The present disclosure adopts the following technical solution.

A buffer component for sliding doors, including a slide rail, where the slide rail is provided with a recess for internal installation, and a buffer is provided in the recess; an outer wall of the slide rail is slidably connected to a wheel, a width of the buffer is less than or equal to a width of the recess; the wheel includes a fixed shell, one side of the fixed shell is provided with an anti-jump component, which is configured to clamp with the buffer; the anti-jump component includes an anti-jump column, a length of a bottom long side of the anti-jump column is less than or equal to the width of the recess.

In some embodiments of the present disclosure, a length of the recess is equal to a length of a guide rail, and a side wall of the recess is provided with a clamp groove; the anti-jump column includes a clamp block, and the clamp block is provided on a side wall of the anti-jump column and is engaged with the clamp groove.

In some embodiments of the present disclosure, the buffer includes a housing, a bottom of the housing is provided with a fitting part, the recess is provided with a connection part, and the connection part is clamped with the fitting part.

In some embodiments of the present disclosure, a damping element is provided in the housing, one end of the damping element is provided with a sliding head, and the sliding head is hinged with a hook; a side wall of the hook is provided with a sliding block, an inner cavity side wall of the housing is provided with an L-shaped recess that is slidably connected with the sliding block; one side of a top of the hook is provided with a first protrusion, and the other side of the top of the hook is provided with a second protrusion, a top of the housing is provided with a top cover, and the top cover is provided with a through recess configured for the first protruding and the second protrusion to pass through.

In some embodiments of the present disclosure, the fixed shell is provided with a second threaded hole, and an interior of the anti-jump component is sleeved with a third bolt; the third bolt is rotatably connected to the anti-jump component and is threaded to the second threaded hole.

In some embodiments of the present disclosure, the fixed shell is provided with a docking part, and the docking part is clamped with the anti-jump component.

In some embodiments of the present disclosure, a side wall of the top cover is provided with a connector, and a side wall of the housing is provided with a docking piece, and the docking piece is clamped with the connector.

In some embodiments of the present disclosure, the fixed shell includes an internally threaded cylinder, and a limit clamp ring is provided on one side of the fixed shell; the limit clamp ring is provided with a movable port configured for the internally threaded cylinder to pass through; one end of the internally threaded cylinder is provided with a fixed wheel, and an interior of the fixed wheel is provided with a fourth bolt, the fourth bolt is threaded connected to the internally threaded cylinder.

In some embodiments of the present disclosure, an outer of the fixed wheel is sleeved with a protective cover, and the fixed wheel is threaded connected with the protective cover.

In some embodiments of the present disclosure, an interior of a side wall of the fixed shell is provided with a second bolt, and the second bolt is rotatably connected to a side wall of the fixed shell; an outer of the internally threaded cylinder is provided with an adjusting shaft, and the adjusting shaft is slidably connected to the internally threaded cylinder; the adjusting shaft is provided with a fourth threaded hole, and the fourth threaded hole is threadedly connected to the second bolt.

The embodiments of the present disclosure have the following beneficial effects.

1. In the present disclosure, the buffer component for sliding doors has been optimized, which significantly improves the convenience of installation and maintenance. The width of the buffer is less than or equal to the width of the recess, so that the installation and replacement of the buffer do not require high-precision adjustment, and there is no need to remove the guide rail and buffer from the sliding door for replacement operation, simplifying the operation steps. The design of separating the anti-jump component from the fixed shell not only effectively avoids a risk of jumping out of a track when the wheel is moved at high speed, enhances the stability and durability of the system, but also allows for separate replacement of the anti-jump column when it is damaged, without the need to replace the entire wheel, reducing maintenance costs. Furthermore, the separation design of the fixed shell and the anti-jump component makes the disassembly and installation process easier and faster, reducing possible errors and further enhancing the user experience.

In summary, the present disclosure solves the problems of inconvenient installation and inconvenient maintenance of traditional sliding door buffer components.

### BRIEF DESCRIPTION OF DRAWINGS

In order to provide a clearer explanation of the technical solution in the embodiments of the present application, a brief introduction will be given to the drawings required for the description of the embodiments. It is obvious that the drawings described below are only some embodiments of the present application. For those skilled in the art, other drawings can be obtained based on these drawings without creative work.

FIG. 1 is a schematic diagram of an overall structure of a buffer component for sliding doors according to the present disclosure.

FIG. 2 is a schematic structural diagram of a wheel of the buffer component for sliding doors of the present disclosure.

FIG. 3 is an exploded view of the wheel of the buffer component for sliding doors according to the present disclosure.

FIG. 4 shows an installation relationship between a fixed shell and an anti-jump component of the buffer component for sliding doors in the present disclosure.

FIG. 5 is a schematic structural diagram of the buffer component for sliding doors in the present disclosure.

FIG. 6 is an exploded view of the buffer component for sliding doors in the present disclosure.

FIG. 7 is a schematic structural diagram of a hook of the buffer component for sliding doors in the present disclosure.

FIG. 8 is a schematic structural diagram of a side wall of a wheel housing of the buffer component for sliding doors of the present disclosure in an arc shape.

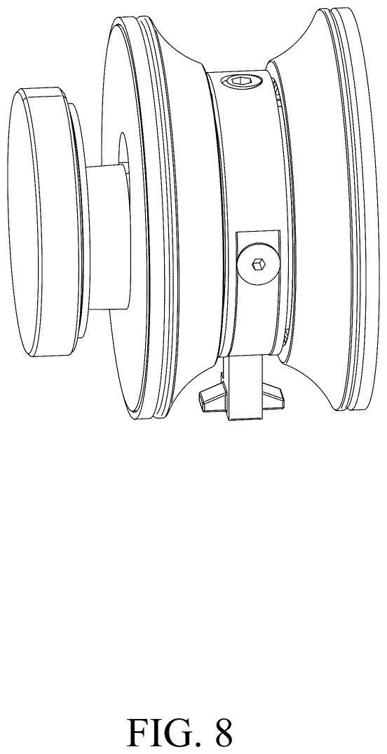

FIG. 9 is a schematic structural diagram of a contact surfaces between a slide rail 1 and the wheel housing 3051 of the sliding door buffer component being arc surfaces according to the present disclosure.

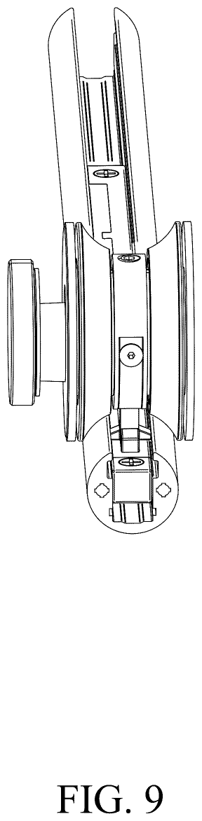

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them. Based on the embodiments in the present disclosure, all other embodiments obtained by those skilled in the art without creative work are within the protection scope of the present disclosure.

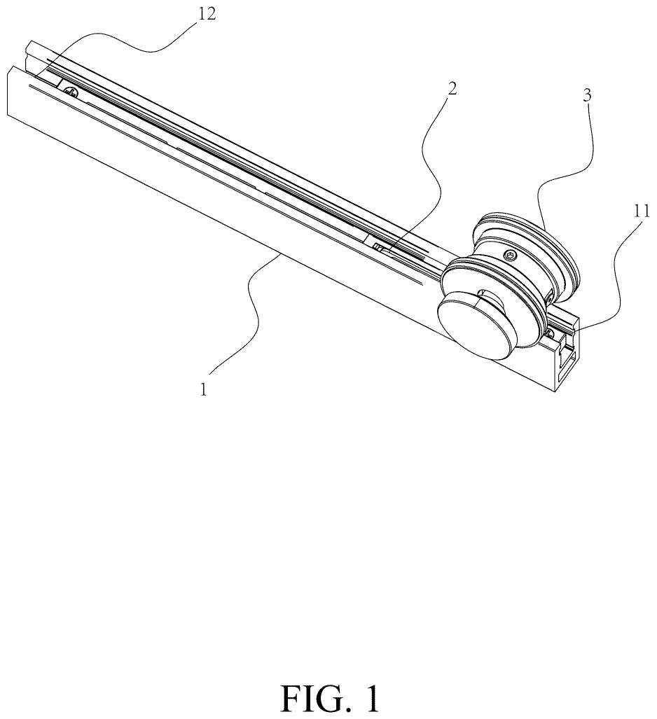

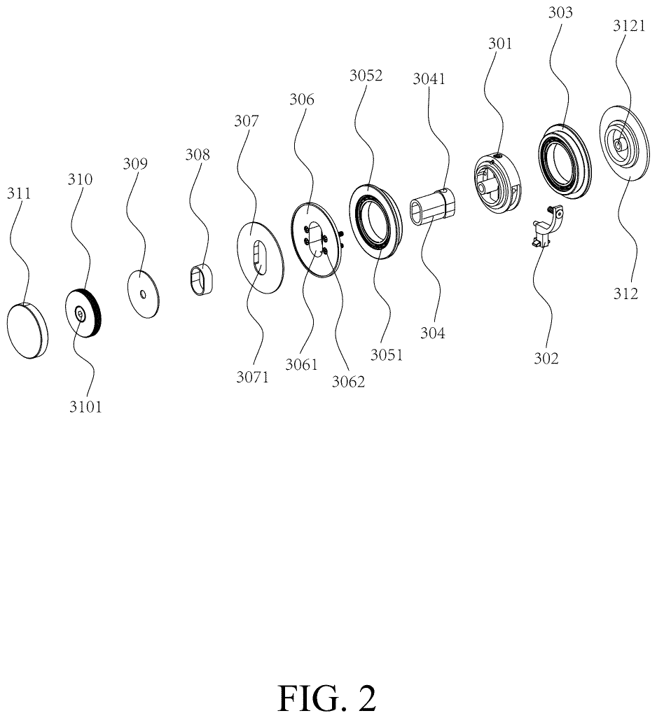

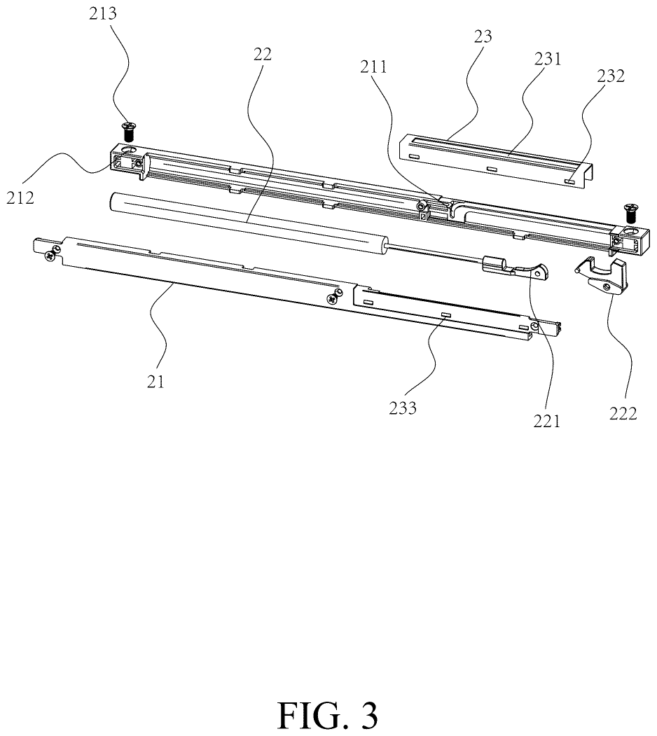

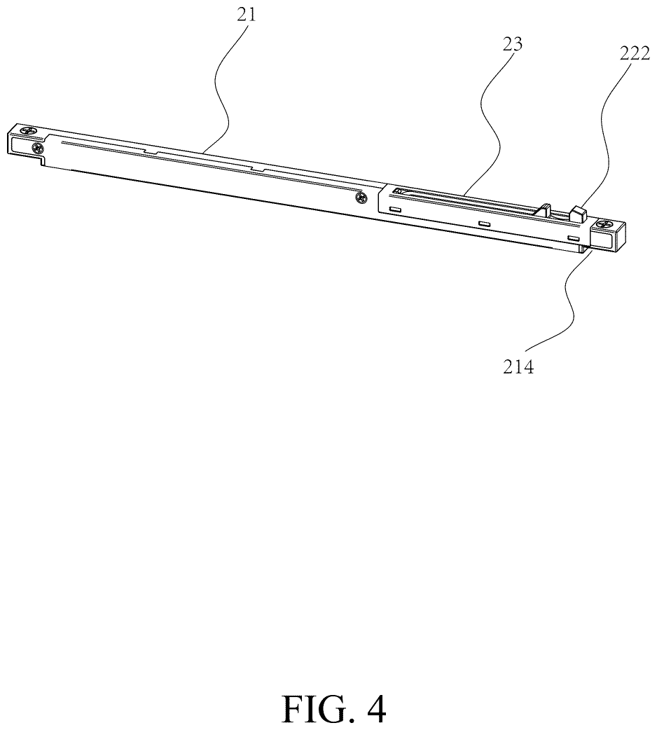

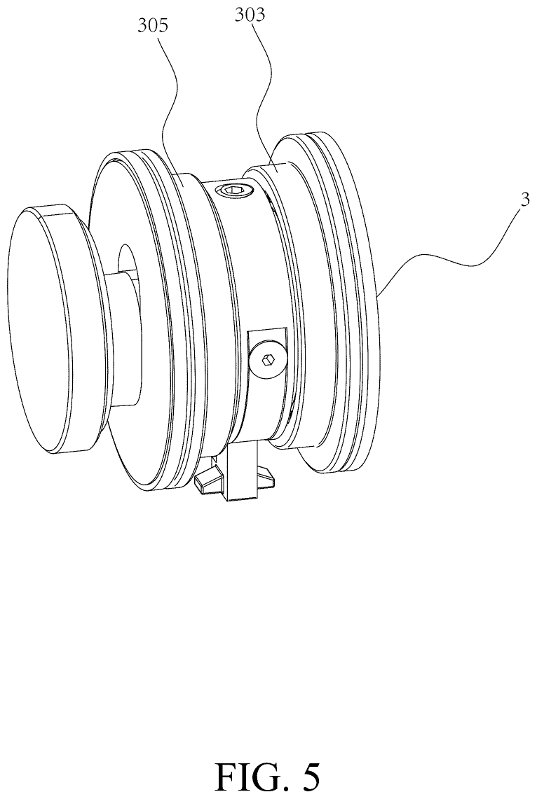

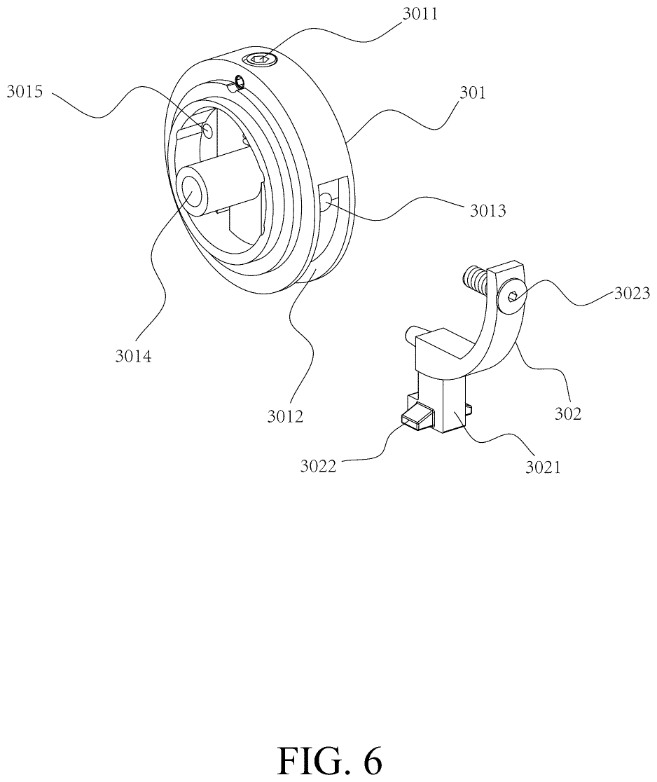

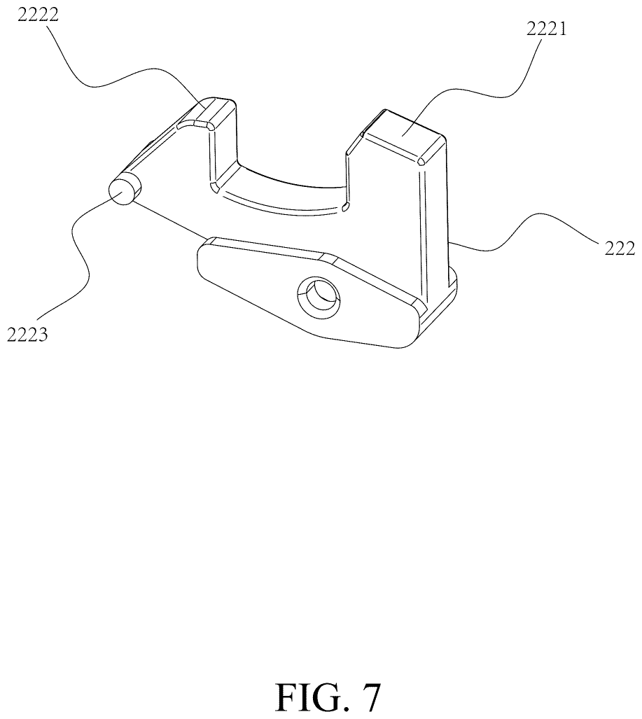

As shown in FIGS. 1 to 7, the present disclosure proposes a buffer component for sliding doors, including a slide rail 1; the slide rail 1 is provided with a recess 12 for internal installation, and a buffer 2 is provided inside the recess 12. An outer wall of the slide rail 1 is slidably connected to a wheel 3, and the wheel 3 is configured for installation on the sliding door. A width of the buffer 2 is less than or equal to a width of the recess 12, and the wheel 3 includes a fixed shell 301. One side of the fixed shell 301 is provided with an anti-jump component 302, which is configured for clamping with the buffer 2. The anti-jump component 302 can prevent the wheel 3 from jumping. The anti-jump component 302 includes an anti-jump column 3021, a length of a long side of the anti-jump column 3021 is less than or equal to the width of the recess 12.

When the sliding door is closed, the wheel 3 is moved along the slide rail 1 and is clamped with the buffer 2 that is provided in the recess 12 of the slide rail through the anti-jump component 302 on its fixed shell 301. In an implementation mode, the anti-jump column 3021 in the anti-jump component 302 will abut against the buffer 2 when the door approaches a fully closed position, thereby gradually slowing down a movement speed of the wheel, allowing the door to be closed smoothly and quietly. This design not only ensures the stability of the door during a closing process, but also effectively prevents damage caused by sudden impacts. Due to the width of the buffer 2 being designed to be less than or equal to the width of the recess 12, the installation and replacement of the buffer become easier, and it can be placed inside the recess 12 without high-precision adjustment. Besides that, the design of the anti-jump component 302 effectively avoids a risk of the wheel 3 jumping off a track during high-speed movement, enhancing the stability and durability of the system. Overall, this improvement not only reduces installation difficulty and minimizes potential errors, but also extends the lifespan of the sliding door buffer components, enhancing the user experience. The fixed shell 301 and the anti-jump component 302 are two separate parts, so that when the wheel 3 needs to be disassembled, only the anti-jump component 302 needs to be separated to complete the disassembly. Similarly, when installing the wheel 3, a user can first install the wheel 3 onto the slide rail 1, and then connect the anti-jump component 302 to the fixed shell 301 so as to complete the installation of the wheel 3 on the slide rail 1. This design reduces the difficulty of loading and unloading. The anti-jump column 3021 is a vulnerable component, and a separate design of the anti-jump component from the fixed shell 301 allows for an independent replacement in the event of damage to the anti-jump column 3021, without the need to replace the entire wheel 3.

In an implementation mode, a length of the recess 12 is equal to a length of the guide rail, and a side wall of the recess 12 is provided with a clamp groove 11. The anti-jump column 3021 includes a clamp block 3022, and the clamp block 3022 is provided on a side wall of the anti-jump column 3021 and is engaged with the clamp groove 11 inside the clamp groove 11. The length of the recess 12 is designed to be equal to the length of the guide rail. This means that the user can place the buffer 2 into the recess 12 at any position on the guide rail, without being limited to a fixed position. The clamp block 3022 is located on a side wall of the anti-jump column 3021 and can be clamped with the clamp groove 11 on the side wall of the recess 12. This design further enhances the stability and reliability of the components, allowing the anti-jump component 302 to be more firmly held within the track when the wheel 3 is moving at high speed, thereby avoiding any possible jumping or derailment. When it is necessary to remove the anti-jump component 302 from the recess 12, simply disconnect the anti-jump component 302 from the fixed shell 301, and then rotate the anti-jump component 302 90 degrees to release the clamp block 3022 from the clamp groove 11. Due to the fact that the length of the bottom long side of the anti-jump column 3021 is less than or equal to the width of the recess 12, the anti-jump component 302 can be easily removed from the recess 12 after rotating 90 degrees. This design makes the disassembly process simple and fast. When it is needed to install the anti-jump component 302 into the recess 12, it only needs to simply reverse the disassembly steps.

In an implementation mode, the fixed shell 301 is provided with a second threaded hole 3013, and an interior of the anti-jump component 302 is sleeved with a third bolt 3023. The third bolt 3023 is rotatably connected to the anti-jump component 302, and is threaded with the second threaded hole 3013. Through a threaded connection design between the third bolt 3023 and the second threaded hole 3013, the anti-jump component 302 can be firmly fixed on the fixed shell 301, thereby avoiding loosening caused by long-term use or external impact. By connecting the third bolt 3023 with the second threaded hole 3013, the user can more conveniently and quickly complete the installation and maintenance of the fixed shell 301 and the anti-jump component 302.

In an implementation mode, the fixed shell 301 is provided with a docking part 3012, and the docking part 3012 is clamped with the anti-jump component 302. The docking part 3012 is a groove body that accommodates the anti-jump component 302. When installing the anti-jump component 302, first align and insert it into the groove body of the docking part 3012 to firmly clamp it together. The groove body can provide guidance for the installation of the anti-jump component 302, thereby avoiding installation deviation of the anti-jump component 302.

In an implementation mode, the buffer 2 includes a housing 21, a bottom of the housing 21 is provided with a fitting part 214, and the recess 12 is provided with a connection part, which is clamped with the fitting part 214. By a clamping design between the fitting part 214 and the connection part, the buffer 2 can be limited within the recess 12 to prevent the buffer 2 from moving. The connection part and the fitting part 214 can provide guidance for the installation of the buffer 2, ensuring that the buffer 2 can be accurately positioned during the installation process. Which greatly simplifies the installation process, reduces operational difficulty and time.

In an implementation mode, the connection part is a convex block, and the fitting part 214 is a groove body that matches a shape of a convex block. The housing 21 and the fitting part 214 are both provided with a first threaded hole 212, and a first bolt 213 is provided in the first threaded hole 212. The first bolt 213 is threadedly connected to the first threaded hole 212. When the buffer 2 is provided in the recess 12, the convex block is inserted into the groove body of the fitting part 214, thereby forming a stable clamping structure. Through the clamping design between the convex block and the groove body, as well as the threaded connection of the first bolt 213, the buffer 2 is firmly limited in the recess 12, thereby avoiding movement or loosening caused by long-term use or external impact. This dual fixation mechanism not only improves the overall stability of the system, but also extends the service life of the components. The first bolt 213 is threaded connected with the first threaded hole 212, which makes the installation of buffer 2 simple and can be completed without complex high-precision adjustments. Similarly, when replacing or repairing the buffer 2, simply remove the first bolt 213 and separate the convex block from the groove body to easily disassemble, thereby reducing maintenance costs and complexity.

In an implementation mode, the connection part is a recess body, and the fitting part 214 is a recess body that matches the shape of the groove body.

In an implementation mode, a damping element 22 is provided in the housing 21, and one end of the damping element 22 is provided with a sliding head 221. The sliding head 221 is hinged with a hook 222, and a sliding block 2223 is provided on a side wall of the hook 222. An inner cavity side wall of the housing 21 is provided with an L-shaped recess 211 that is slidably connected to the sliding block 2223. One side of a top of the hook 222 is provided with a first protrusion 2221, and the other side of the top of the hook 222 is provided with a second protrusion 2222. A top of the housing 21 is provided with a top cover 23, and the top cover 23 is provided with a through recess 231 configured for the first protrusion 2221 and the second protrusion 2222 to pass through. The damping element 22 is a hydraulic buffer. When the sliding door is opened, the hydraulic buffer is in a locked state, and the sliding block 2223 is located at one end of the L-shaped recess 211 that bends downward. The second protrusion 2222 is tilted into the recess 12 and does not protrude from the recess 12. When the sliding door is closed, the sliding door drives the wheel 3 to move. When it moves to the hook 222, the anti-jump column 3021 contacts the first protrusion 2221, the hook 222 is pushed to slide along the L-shaped recess 211. The second protrusion 2222 is protruded from the L-shaped recess 211, thereby gradually compressing the hydraulic buffer, and achieving a smooth closing action. When the sliding door is opened, the anti-jump column 3021 abuts against the second protrusion 2222, the hook 222 is pushed to slide in an opposite direction and return to an initial position.

In an implementation mode, the damping element 22 is one or a combination of hydraulic or pneumatic buffers.

In an implementation mode, a side wall of the top cover 23 is provided with a connector 232, and a side wall of the housing 21 is provided with a docking piece 233, the docking piece 233 is clamped with the connector 232, thereby facilitating the loading and unloading of the top cover 23, thus facilitating the maintenance of the buffer 2.

In an implementation mode, the fixed shell 301 includes an internally threaded cylinder 3014. One side of the fixed shell 301 is provided with a limit clamp ring 306, which is provided with a movable port 3061 configured for the internally threaded cylinder 3014 to pass through. One end of the internally threaded cylinder 3014 is provided with a fixed wheel 310, an interior of the fixed wheel 310 is sleeved with a fourth bolt 3101 and is threaded with the internally threaded cylinder 3014. The sliding door is provided between the limit clamp ring 306 and the fixed wheel 310. A specific installation process is as follows: first, open a hole on the sliding door, thread the internally threaded cylinder through the hole, and then clamp the sliding door with the fixed wheel 310 and the limit clamp ring 306. The fourth bolt 3101 is configured to connect and tighten the fixed wheel 310 and the limit clamp ring 306, ensuring that the sliding door is firmly fixed between the two. Through a cooperation design of the internally threaded cylinder 3014, fixed wheel 310, and limit clamp ring 306, the sliding door can be firmly fixed between the two and will not loosen or fall off during high-speed movement. The threaded connection between the fourth bolt 3101 and the internally threaded cylinder 3014 further enhances the fixing effect. The design of the fourth bolt 3101 allows for easy and quick installation and removal of the fixed wheel 310, thereby facilitating the installation of the wheel 3 on the sliding door and facilitating later maintenance.

In an implementation mode, an outer of the fixed wheel 310 is sleeved with a protective cover 311, and the fixed wheel 310 is threaded with the protective cover 311. A threaded connection design between the protective cover 311 and the fixed wheel 310 makes the installation and disassembly process very simple. The user only needs to rotate the protective cover 311 to complete installation or removal operations, without the need for complex tools or high-precision adjustments. The design of the protective cover 311 effectively prevents the fixed wheel 310 from being corroded by external environments such as dust, moisture, etc., extending the service life of the fixed wheel 310, and also avoiding the exposure of the fourth bolt 3101, thereby improving its aesthetics.

In an implementation mode, an interior of a side wall of the fixed shell 301 is sleeved with a second bolt 3011, and the second bolt 3011 is rotatably connected to the side wall of the fixed shell 301. An outer of the internally threaded cylinder 3014 is sleeved with an adjusting shaft 304, and the adjusting shaft 304 is slidably connected to the internally threaded cylinder 3014. The adjusting shaft 304 is provided with a fourth threaded hole 3041, and the fourth threaded hole 3041 is threaded connected to the second bolt 3011. By rotating the second bolt 3011, the lifting and lowering of the adjusting shaft 304 can be controlled, thereby controlling the lifting and lowering of the sliding door. With a threaded connection of the second bolt 3011 and the fourth threaded hole 3041, the user can adjust the height of the sliding door very accurately. This design allows for fine-tuning to ensure smooth operation of the sliding door under different ground conditions, thereby improving its flexibility and adaptability. A sliding connection design between the adjusting shaft 304 and the internally threaded cylinder 3014 simplifies the installation process, and height adjustment can be completed without complex tools or high-precision adjustments.

In an implementation mode, a first roller 303 is provided on one side of the fixed shell 301, and a second roller 305 is provided on the other side of the fixed shell 301. Both the first roller 303 and the second roller 305 include bearings 3052, and outers of the bearings 3052 are sleeved with a wheel housing 3051 that directly contacts the slide rail 1, thereby avoiding a direct friction between the fixed shell 301 and the slide rail 1. Through the design of the first roller 303 and the second roller 305, the sliding door no longer directly contacts the slide rail 1, but rolls through the wheel housing 3051. This design greatly reduces friction, rendering the sliding door smoother during the sliding process, reducing the difficulty of user operation, and improving the user experience. Due to a reduction of direct friction, the wear of the slide rail 1 and the fixed shell 301 is significantly reduced, extending the service life of the system. And the design of the bearing 3052 further reduces the wear of the roller itself. A rolling contact between the wheel housing 3051 and the slide rail 1 produces less noise compared to direct friction. The roller design is easy to disassemble and replace. If one roller is worn or damaged, the user can easily disassemble it and replace it with a new roller without the need for extensive repairs to the entire wheel 3.

In an implementation mode, a contact surface between the slide rail 1 and the wheel housing 3051 is flat. A contact surface between the wheel housing 305 and the slide rail 1 is flat.

In an implementation mode, the contact surface between the slide rail 1 and the wheel housing 3051 is an arc surface. The contact surface between the wheel housing 3051 and the slide rail 1 is an arc surface.

In an implementation mode, the limit clamp ring 306 is provided with at least one connection screw 3062, and the fixed shell 301 is provided with at least one third threaded hole 3015 that is threaded with the connection screw 3062.

In an implementation mode, a cover plate 307 is provided on one side of the limit clamp ring 306, and a gasket 309 is provided between the cover plate 307 and the fixed wheel 310. An outer of the adjusting shaft 304 is sleeved with a backup ring 308 to prevent a direct contact between the adjusting shaft 304 and the sliding door.

The present disclosure provides a buffer component for sliding doors, including a slide rail 1, the slide rail 1 is provided with a recess 12 for internal installation, and a buffer 2 is provided in the recess 12. An outer wall of the slide rail 1 is slidably connected to a wheel 3, and the wheel 3 is configured to be provided on the sliding door. A width of the buffer 2 is less than or equal to a width of the recess 12, and the wheel 3 includes a fixed shell 301. One side of the fixed shell 301 is provided with an anti-jump component 302, which is configured to clamp with the buffer 2. The anti-jump component 302 can prevent the wheel 3 from jumping. The anti-jump component 302 includes an anti-jump column 3021, and a length of a bottom long side of the anti-jump column 3021 is less than or equal to a width of the recess 12.

When the sliding door is closed, the wheel 3 is moved along the slide rail 1 and is clamped with the buffer 2 provided in the recess 12 of the slide rail through the anti-jump component 302 on its fixed shell 301. In an implementation mode, the anti-jump column 3021 in the anti-jump component 302 will abut against the buffer 2 when the door approaches a fully closed position, thereby gradually slowing down a movement speed of the wheels, and allowing the door to close smoothly and quietly. This design not only ensures the stability of the door during a closing process, but also effectively prevents damage caused by sudden impacts. Due to the width of the buffer 2 being designed to be less than or equal to the width of the recess 12, the installation and replacement of the buffer become easier, and it can be placed inside the recess 12 without high-precision adjustment. Besides that, the design of the anti-jump component 302 effectively avoids a risk of the wheel 3 jumping off a track during high-speed movement, enhancing the stability and durability of the system. Overall, this improvement not only reduces installation difficulty and minimizes potential errors, but also extends the lifespan of the sliding door buffer components, enhancing the user experience. The fixed shell 301 and the anti-jump component 302 are two separate parts, so that when the wheel 3 needs to be disassembled, only the anti-jump component 302 needs to be separated so as to complete the disassembly. Similarly, when installing the wheel 3, the user can first install the wheel 3 onto the slide rail 1, and then connect the anti-jump component 302 to the fixed shell 301 so as to complete the installation of the wheel 3 on the slide rail 1. This design reduces the difficulty of loading and unloading. The anti-jump column 3021 is a vulnerable component, and its separate design of the anti-jump column 3021 and the fixed shell 301 allows for independent replacement in the event of damage to the anti-jump column 3021, without the need to replace the entire wheel 3.

A length of the recess 12 is equal to a length of a guide rail, and a side wall of the recess 12 is provided with a clamp groove 11. The anti-jump column 3021 includes a clamp block 3022, and the clamp block 3022 is provided on one side wall of the anti-jump column 3021. The clamp groove 11 is engaged with the clamp groove 11. The length of the recess 12 is designed to be equal to the length of the guide rail. This means that the user can place the buffer 2 into the recess 12 at any position on the guide rail, without being limited to a fixed position. The clamp block 3022 is located on one side wall of the anti-jump column 3021 and can be clamped with the clamp groove 11 on the side wall of the recess 12. This design further enhances the stability and reliability of the components, allowing the anti-jump component 302 to be more firmly held within a track when the wheel 3 is moving at high speed, avoiding any possible jumping or derailment. When it is necessary to remove the anti-jump component 302 from the recess 12, simply disconnect the anti-jump component 302 from the fixed shell 301, and then rotate the anti-jump component 302 90 degrees to release the clamp block 3022 from the clamp groove 11. Due to the fact that a length of a bottom long side of the anti-jump column 3021 is less than or equal to the width of the recess 12, the anti-jump component 302 can be easily removed from the recess 12 after rotating 90 degrees. This design makes the disassembly process simple and fast. When it is needed to install the anti-jump component 302 into the recess 12, it only needs to simply reverse the disassembly steps.

The fixed shell 301 is provided with a second threaded hole 3013, and an interior of the anti-jump component 302 is sleeved with a third bolt 3023. The third bolt 3023 is rotatably connected to the anti-jump component 302, and is threaded with the second threaded hole 3013. Through a threaded connection design between the third bolt 3023 and the second threaded hole 3013, the anti-jump component 302 can be firmly fixed on the fixed shell 301, avoiding loosening caused by long-term use or external impact. With a threaded connection of the third bolt 3023 with the second threaded hole 3013, the user can more conveniently and quickly complete the installation and maintenance of the fixed shell 301 and the anti-jump component 302. The fixed shell 301 is provided with a docking part 3012, and the docking part 3012 is clamped with the anti-jump component 302. The docking part 3012 is a groove body that accommodates the anti-jump component 302. When installing the anti-jump component 302, first align and insert it into the grove body of the docking part 3012 to firmly clamp it together. The groove body can provide guidance for the installation of the anti-jump component 302, avoiding installation deviation of the anti-jump component 302.

The buffer 2 includes a housing 21, a fitting part 214 is provided at a bottom of the housing 21, and a connection part provided in the recess 12, and the connection part is clamped with the fitting part 214. With a clamping design between the fitting part 214 and the connection part, the buffer 2 can be limited within the recess 12 to prevent the buffer 2 from moving. A clamp connection of the connection part and the fitting part 214 can provide guidance for the installation of the buffer 2, ensuring that buffer 2 can be accurately positioned during the installation process, thereby greatly simplifying the installation process, reducing operational difficulty and time. The fitting part 214 is a grove body that matches a shape of a convex block. The housing 21 and the fitting part 214 are both provided with a first threaded hole 212, and a first bolt 213 is provided in the first threaded hole 212. The first bolt 213 is threaded to the first threaded hole 212. When the buffer 2 is installed in the recess 12, the convex block is inserted into the groove body of the fitting part 214, thereby forming a stable clamping structure. Through a clamping design between the convex block and the groove body, as well as a threaded connection of the first bolt 213, the buffer 2 is firmly limited in the recess 12, thereby avoiding movement or loosening caused by long-term use or external impact. This dual fixation mechanism not only improves the overall stability of the system, but also extends the service life of the components. The first bolt 213 is threaded connected with the first threaded hole 212, which makes the installation of the buffer 2 simple and can be completed without complex high-precision adjustments. Similarly, when replacing or repairing the buffer 2, simply remove the first bolt 213 and separate the convex block from the groove body to easily disassemble, reducing maintenance costs and complexity.

A damping element 22 is provided in the housing 21, and one end of the damping element 22 is provided with a sliding head 221. The sliding head 221 is hinged with a hook 222, one side wall of the hook 222 is provided with a sliding block 2223. An inner cavity side wall of the housing 21 is provided with an L-shaped recess 211 that is slidably connected with the sliding block 2223. One side of a top of the hook 222 is provided with a first protrusion 2221, and the other side of the top of the hook 222 is provided with a second protrusion 2222. A top of the housing 21 is provided with a top cover 23, and the top cover 23 is provided with a through recess 231 configured for the first protrusion 2221 and the second protrusion 2222 to pass through. The damping element 22 is a hydraulic buffer. When the sliding door is opened, the hydraulic buffer is in a locked state, and the sliding block 2223 is at one end of the L-shaped recess 211 that bends downward. The second protrusion 2222 is tilted into the recess 12 and does not protrude from the recess 12. When the sliding door is closed, the sliding door drives the wheel 3 to move. When it moves to the hook 222, the anti-jump column 3021 contacts the first protrusion 2221, the hook 222 is pushed to slide along the L-shaped recess 211. The second protrusion 2222 is protruded from the L-shaped recess 211, thereby gradually compressing the hydraulic buffer, thus achieving a smooth closing action. When the sliding door is opened, the anti-jump column 3021 abuts against the second protrusion 2222, the hook 222 is pushed to slide in an opposite direction and return to an initial position. A side wall of the top cover 23 is provided with a connector 232, and a side wall of the housing 21 is provided with a docking piece 233, and the docking piece 233 is clamped with the connector 232, thereby facilitating the loading and unloading of the top cover 23, thus facilitating the maintenance of the buffer 2.

The fixed shell 301 includes an internally threaded cylinder 3014. One side of the fixed shell 301 is provided with a limit clamp ring 306, and the limit clamp ring 306 is provided with a movable port 3061 configured for the internally threaded cylinder 3014 to pass through. One end of the internally threaded cylinder 3014 is provided with a fixed wheel 310, an interior of the fixed wheel 310 is sleeved with a fourth bolt 3101. The fourth bolt 3101 is threaded connected with the internally threaded cylinder 3014. The sliding door is provided between the limit clamp ring 306 and the fixed wheel 310. A specific installation process is as follows: first, open a hole on the sliding door, thread the internally threaded cylinder 3014 through the hole, and then clamp the sliding door with the fixed wheel 310 and the limit clamp ring 306. The fourth bolt 3101 is configured to connect and tighten the fixed wheel 310 and the limit clamp ring 306, ensuring that the sliding door is firmly fixed between the two. Through a cooperation design of the internally threaded cylinder 3014, fixed wheel 310, and limit clamp ring 306, the sliding door can be firmly fixed between the two and will not loosen or fall off during high-speed movement. A threaded connection between the fourth bolt 3101 and the internally threaded cylinder 3014 further enhances the fixing effect. The design of the fourth bolt 3101 allows for easy and quick installation and removal of the fixed wheel 310, facilitating the installation of the wheel 3 on the sliding door and facilitating later maintenance. An outer of the fixed wheel 310 is sleeved with a protective cover 311, and the fixed wheel 310 is threaded connected with the protective cover 311. A threaded connection design between the protective cover 311 and the fixed wheel 310 makes the installation and disassembly process very simple. The user only needs to rotate the protective cover 311 to complete installation or removal operations, without the need for complex tools or high-precision adjustments. The design of the protective cover 311 effectively prevents the fixed wheel 310 from being corroded by external environments such as dust, moisture, etc., extending the service life of the fixed wheel 310, and also avoiding the exposure of the fourth bolt 3101, thereby improving its aesthetics.

In an implementation mode, an interior of a side wall of the fixed shell 301 is sleeved with a second bolt 3011, and the second bolt 3011 is rotatably connected to a side wall of the fixed shell 301. An outer of the internally threaded cylinder 3014 is sleeved with an adjusting shaft 304, and the adjusting shaft 304 is slidably connected to the internally threaded cylinder 3014. The adjusting shaft 304 is provided with a fourth threaded hole 3041, and the fourth threaded hole 3041 is threaded with the second bolt 3011. By rotating the second bolt 3011, the lifting and lowering of the adjusting shaft 304 can be controlled, thereby controlling the lifting and lowering of the sliding door. By a threaded connection of the second bolt 3011 and the fourth threaded hole 3041, the user can adjust the height of the sliding door very accurately. This design allows for fine-tuning to ensure smooth operation of the sliding door under different ground conditions, improving its flexibility and adaptability. The sliding connection design between the adjusting shaft 304 and the internally threaded cylinder 3014 simplifies the installation process, and height adjustment can be completed without complex tools or high-precision adjustments.

One side of the fixed shell 301 is provided with a first roller 303, and the other side of the fixed shell 301 is provided with a second roller 305. Both the first roller 303 and the second roller 305 include bearings 3052, and outers of the bearings 3052 are provided with a wheel housing 3051 that directly contacts the slide rail 1, thereby avoiding a direct friction between the fixed shell 301 and the slide rail 1. Through the design of the first roller 303 and the second roller 305, the sliding door no longer directly contacts the slide rail 1, but rolls through the wheel housing 3051. This design greatly reduces friction, rendering the sliding door smoother during the sliding process, reducing the difficulty of user operation, and improving the user experience. Due to the reduction of direct friction, the wear of the slide rail 1 and the fixed shell 301 is significantly reduced, extending the service life of the system. Meanwhile, the design of the bearing 3052 further reduces the wear of the roller itself. The rolling contact between the wheel housing 3051 and the slide rail 1 produces less noise compared to direct friction. The roller design is easy to disassemble and replace. If one roller is worn or damaged, the user can easily disassemble it and replace it with a new roller without the need for extensive repairs to the entire wheel 3. A contact surface between the slide rail 1 and the wheel housing 3051 is flat. A contact surface between the wheel housing 305 and the slide rail 1 is flat.

In an implementation mode, the contact surface between the slide rail 1 and the wheel housing 3051 is an arc surface. The contact surface between the wheel shell 305 and the slide rail 1 is an arc surface.

The working principle of the present disclosure is as follows.

When the sliding door is closed, the wheel 3 is moved along the slide rail 1 and is clamped with the buffer 2 provided in the recess 12 of the slide rail through the anti-jump component 302 on its fixed shell 301. In an implementation mode, the anti-jump column 3021 in the anti-jump component 302 will abut against the buffer 2 when the door approaches the fully closed position, gradually slowing down the movement speed of the wheel 3, allowing the door to close smoothly and quietly. The design of the anti-jump component 302 effectively avoids the risk of the wheel 3 jumping off the track during high-speed movement, enhancing the stability and durability of the component. Besides that, the buffer 2 is clamped with the connection part in the recess 12 through the fitting part 214, ensuring its stable positioning within the recess 12 and avoiding movement or loosening caused by long-term use or external impact.

The fixed shell 301 includes an internally threaded cylinder 3014, a limit clamp ring 306 is provided on one side of the internally threaded cylinder 3014. The limit clamp ring 306 is provided with a movable port 3061 configured for the internally threaded cylinder 3014 to pass through. One end of the internally threaded cylinder 3014 is provided with a fixed wheel 310, and the fixed wheel 310 is sleeved with a fourth bolt 3101. The fourth bolt 3101 is threaded with the internally threaded cylinder 3014. The sliding door is secured by opening a hole in the door, the internally threaded cylinder 3014 passing through the hole, and then clamping the sliding door with the fixed wheel 310 and the limit clamp ring 306 to ensure that the sliding door is firmly fixed between the two. This design not only improves the stability of the system, but also facilitates the installation and disassembly of the wheel 3, simplifying the maintenance process.

A damping element 22 (hydraulic buffer) is provided in the housing 21, and one end of the housing 21 is provided with a sliding head 221, the sliding head 221 is hinged with a hook 222. A side wall of the hook 222 is provided with a sliding block 2223, and an inner cavity side wall of the housing 21 is provided with an L-shaped recess 211 that is slidably connected to the sliding block 2223. When the sliding door is closed, the wheel 3 drives the anti-jump column 3021 to contact the first protrusion 2221 of the hook 222, the hook 222 is pushed to slide along the L-shaped recess 211, thereby gradually compressing the hydraulic buffer, and achieving a smooth closing action. When the sliding door is opened, the anti-jump column 3021 abuts against the second protrusion 2222, the hook 222 is pushed to slide in the opposite direction and return to its initial position. The top cover 23 is clamped with the docking piece 233 of the housing 21 through the connector 232, which facilitates the loading and unloading of the top cover 23 and the maintenance of the buffer 2.

In summary, the present disclosure solves the problems of inconvenient installation and maintenance of traditional sliding door buffer components.

It should be understood that terms “first”, “second”, etc. are used in the present disclosure to describe various information, but these terms should not be limited to these terms. These terms are only used to distinguish information of the same type from each other. For example, without departing from the scope of the present disclosure, the “first” information may also be referred to as the “second” information, and similarly, the “second” information may also be referred to as the “first” information. In addition, terms “center”, “up”, “down”, “left”, “right”, “vertical”, “horizontal”, “inside”, “outside” and other directional or positional relationships indicated are based on the directional or positional relationships shown in the accompanying drawings, only for the convenience of describing the present disclosure and simplifying the description, and do not indicate or imply that the device or component referred to must have a specific orientation, be constructed and operated in a specific orientation, and therefore cannot be understood as a limitation of the present disclosure.

The above is the preferred embodiment of the present disclosure. It should be noted that for those skilled in the art, several improvements and modifications can be made without departing from the principles of the present disclosure. These improvements and modifications are also considered to be within the protection scope of the present disclosure.

What is claimed is:

1. A buffer component for sliding doors, comprising a slide rail, wherein the slide rail is provided with a recess for internal installation, and a buffer is provided in the recess;
an outer wall of the slide rail is slidably connected to a wheel,
a width of the buffer is less than or equal to a width of the recess;
the wheel comprises a fixed shell, one side of the fixed shell is provided with an anti-jump component, which is configured to clamp with the buffer,
the anti-jump component comprises an anti-jump column, a length of a bottom long side of the anti-jump column is less than or equal to the width of the recess.

2. The buffer component for sliding doors according to claim 1, wherein a length of the recess is equal to a length of a guide rail, and a side wall of the recess is provided with a clamp groove;
the anti-jump column comprises a clamp block, and the clamp block is provided on a side wall of the anti-jump column and is engaged with the clamp groove.

3. The buffer component for sliding doors according to claim 1, wherein the buffer comprises a housing, a bottom of the housing is provided with a fitting part, the recess is provided with a connection part, and the connection part is clamped with the fitting part.

4. The buffer component for sliding doors according to claim 3, wherein a damping element is provided in the housing, one end of the damping element is provided with a sliding head, and the sliding head is hinged with a hook;
a side wall of the hook is provided with a sliding block, an inner cavity side wall of the housing is provided with an L-shaped recess that is slidably connected with the sliding block;
one side of a top of the hook is provided with a first protrusion, and the other side of the top of the hook is provided with a second protrusion,
a top of the housing is provided with a top cover, and the top cover is provided with a through recess configured for the first protruding and the second protrusion to pass through.

5. The buffer component for sliding doors according to claim 1, wherein the fixed shell is provided with a second threaded hole, and an interior of the anti-jump component is sleeved with a third bolt;
the third bolt is rotatably connected to the anti-jump component and is threaded to the second threaded hole.

6. The buffer component for sliding doors according to claim 1, wherein the fixed shell is provided with a docking part, and the docking part is clamped with the anti-jump component.

7. The buffer component for sliding doors according to claim 4, wherein a side wall of the top cover is provided with a connector, and a side wall of the housing is provided with a docking piece, and the docking piece is clamped with the connector.

8. The buffer component for sliding doors according to claim 1, wherein the fixed shell comprises an internally threaded cylinder, and a limit clamp ring is provided on one side of the fixed shell;
the limit clamp ring is provided with a movable port configured for the internally threaded cylinder to pass through;
one end of the internally threaded cylinder is provided with a fixed wheel, and an interior of the fixed wheel is provided with a fourth bolt, the fourth bolt is threaded connected to the internally threaded cylinder.

9. The buffer component for sliding doors according to claim 8, wherein an outer of the fixed wheel is sleeved with a protective cover, and the fixed wheel is threaded connected with the protective cover.

10. The buffer component for sliding doors according to claim 1, wherein an interior of a side wall of the fixed shell is provided with a second bolt, and the second bolt is rotatably connected to a side wall of the fixed shell;
an outer of the internally threaded cylinder is provided with an adjusting shaft, and the adjusting shaft is slidably connected to the internally threaded cylinder;
the adjusting shaft is provided with a fourth threaded hole, and the fourth threaded hole is threadedly connected to the second bolt.
